(19) United States
(12) Patent Application Publication
(10) Pub. No.: US 2020/0029558 A1
(43) Pub. Date: Jan. 30, 2020

(54) Biocidal Microcapsules for Biofouling Control

(71) Applicant: Greenseal Research Ltd, Lisboa (PT)

(72) Inventors: Ana Clara Lopes Marques, Moscavide-Portela (PT); Elisabete Ribeiro Silva Geraldes, Sao Joao Da Talha (PT); Joao Carlos Moura Bordado, Lisboa (PT)

(21) Appl. No.: 16/335,672

(22) PCT Filed: Sep. 22, 2017
(86) PCT No.: PCT/EP2017/074085

§ 371 Date: Mar. 21, 2019

(30) Foreign Application Priority Data
Sep. 22, 2016 (EP) 16190208.5

(51) Int. Cl. A01N 25/28; B01J 13/16; C09D 5/14; C09D 5/16

(52) U.S. Cl. CPC A01N 25/28; C09D 5/1687; C09D 5/14; B01J 13/16

(57) ABSTRACT

The present invention is directed to bioactive microcapsules and to the process for their production. More in particular, the present invention relates to the production of bioactive microcapsules, or porous microspheres by a water-in-oil (W/O) microemulsion method combined with interfacial polymerization, involving the full or partial covalent immobilization of biocides and/or modified biocides within the microcapsules shell, or porous microspheres. In addition, the present invention further relates to the use of said bioactive microcapsules/microspheres for controlled release of biocides in antifouling application and their incorporation in matrices such as marine coatings.

### FIELD OF THE INVENTION

The present invention is directed to bioactive microcapsules and to the process for their production. More in particular, the present invention relates to the production of bioactive microcapsules, or porous microspheres by a water-in-oil (W/O) microemulsion method combined with interfacial polymerization, involving the full or partial covalent immobilization of biocides and/or modified biocides within the microcapsules shell, or porous microspheres. In addition, the present invention further relates to the use of said bioactive microcapsules/microspheres, partial active by contact mode, for biofouling control, when incorporated in matrices such as polymeric coatings.

### BACKGROUND OF THE INVENTION

The adhesion and growth of micro/macroorganisms on surfaces, particularly in contact with aqueous mediums, is one of the most serious problems in a wide range of industrial sectors (e.g. marine transport, exterior walls as building façades, etc.). This undesired bio-attach, known as biofouling can promote substrate deterioration, systems clogging and fluids contamination, resulting on costly maintenance and retrofitting consequences [Bott, T. R. (2011). Industrial Biofouling, 1st ed. Elsevier, United Kingdom]. For instance, on shipping industry, perhaps one of the most prominent examples of biofouling burden, this bio-attach and accumulation on ships hulls can lead to drag friction increases up to 40% and subsequent fuel consumption and Greenhouse gas emissions increases [Dahlbäck, B., Blanck, H., and Nydén, M. (2010). Coastal Marine Science, 34, 212-215; Callow, J. A., and Callow, M. E. (2011). Nature Communications, 2, 1-10].

So far, the most efficient and conventional methods to control biofouling on surfaces are mainly based on a chemical strategy which comprise the direct and/or controlled releasing of biocides into the contaminated surface [Bott, T. R. (2011). Industrial Biofouling, 1st ed. Elsevier, United Kingdom; Banerjee, I., Pangule, R. C., and Kane, R. S. (2011). Advanced Materials, 23, 690-718].

Most of these employ coatings incorporating biocides which act by a controllable releasing mechanism. However, the main drawbacks of those systems is the poor control on biocides releasing and the potential degradation of the biocides or toxic agents in the final product such as coating matrix. In particular, most coatings suffer of premature leakage of biocides, reducing its antifouling action before the end of coatings lifetime. Alternatively, higher biocides contents can be used to reach the required lifecycle, but the continued releasing of those toxic agents into the environment has proven to cause serious side effects on ecosystems, mainly owing to the ecotoxicity and cumulative effect of the applied bioactive agents. Therefore, rigid international regulations have been issued (BPD EU Regulation, 2012), and more are expected to come in a near future, which comprises the use of some current biocides and/or biocidal products. New alternative strategies have arisen, with particular interest on the microencapsulation technology [M. A. Trojer, L. Nordstierna, J. Bergek, H. Blanck, K. Holmberg, M. Nydén, Advances in Colloid and Interface Science, Vol. 222 (2014) 18-43; S. Jämsä, R. Mahlberg, U. Holopainen, J. Ropponen, A. C. Ritschkoff, Progress in Organic Coatings, Vol. 76 (2013) 269-276]. Microencapsulation of bioactive agents has emerged as a potential strategy to provide a controlled release of toxic agents into the contaminated area, as well as to protect the bioactive agent from the surrounding environment. However, the main desirable function of microcapsules is to control, i.e. retard, the release of the toxic or bioactive agent and, therefore promoting a longer biocidal and/or antimicrobial protection effect. A number of encapsulation methodologies have been developed and continuously improved to provide encapsulated bioactive agents for a wide range of applications, such as: internal phase separation, interfacial polymerization, formation of multiple emulsions, Layer-by-Layer adsorption of polyelectrolytes, soft templating techniques or combinations thereof. The selection of the method is mainly based on the bioactive agents physical/chemical properties (composition, size, physicalstate, hydrophilic/hydrophobic, compatibility) and on the desired release rate and profile.

Nonetheless, and despite the recognised improvement on the bioactive agents releasing mechanisms, these methods provide bioactive microcapsules that still act by a releasing of toxic biocides into the contaminated medium.

Alternative efforts have been done in order to find non-toxic antifouling systems involving encapsulation, which are usually focused on non-biocidal or biocide-free approaches, such as the encapsulation of enzymes [Ma, L., Lu, W., and Wen, J. (2009). Journal of Molecular Catalysis B: Enzymatic, 56, 102-107]. However, the approaches based on biocide releasing still are the most efficient and reliable for biofouling control. Release strategies based on soluble polymeric matrix and insoluble matrix has proven to be insufficient due to limited life time, less than 12 to 15 months, of the coatings formulated therewith. Although insoluble matrix tend to be higher in mechanical strength and stability to oxidation and photochemical degradation, both matrices have a high release of the biocide into the aquatic environment with limited action to some microorganism species and have to be combined with other bioactive agents with respect to efficiency. This is equally the case with so-called Self-polishing coatings which are polymers that produce a soluble microlayer, through a “slow hydrolysis” mechanism, controlled by copolymeric chains lateral groups [Lejars, M., Margaillan, A., and Bressy, C. (2012). Chemical Reviews, 112, 4347-4390].

From the above it is clear that there remains a need for environmental friendly biocidal strategies which are able to combine higher efficiency against biofouling and which are less to non-toxic for the environment.

Against the above needs, the present invention provides for biocidal, preferably polyurethane-polyurea, microcapsules characterized by a core-shell morphology, or porous polymeric microspheres, which can offer a combined biocidal action, by biocide release and by contact from a partial/total biocides immobilization by covalent bonds within the microcapsules shell, or microspheres. This present invention also allows the encapsulation of different bioactive agents in a same microcapsule, extending its range of action and ability to be adapted to different conditions and promoters of biofouling, therefore, supporting synergistic actions of the applied bioactive agents.

### DETAILED DESCRIPTION OF THE INVENTION

Microcapsules (MC's) are particles comprising an inner core containing the active substance and which is surrounded by a polymer layer (polymer membrane). These can be mononuclear, when these are constituted by a single core, or polynuclear, if it is in the presence of more than one core within the shell.

The present invention is directed to different embodiments including biocide containing microcapsules having a core shell morphology or porous polymeric microsphere characterized in that the biocide is fully or partially immobilized within the shell of the microcapsule or porous microsphere. According to another embodiment, the biocide containing microcapsules is further characterized whereby the biocide is partially encapsulated within the core of the microcapsule. According to a specific embodiment, the material of the shell is a polymer, preferably the polymer is selected from the group comprising polyurethane/polyurea polymer. According to a further embodiment, the present invention relates to polymeric compositions comprising the biocide containing microcapsule such as coatings, adhesives, polymeric materials. In yet another embodiment, the present invention relates to the use of a microcapsule to provide biological effect by contact with the organisms to be treated therewith and/or the use of microcapsules to provide biological effect by release and by contact with the organisms to be treated therewith. The process embodiments of the present invention relate to preparing biocide containing microcapsules having a core shell morphology or porous polymeric microsphere said process comprising a water-in-oil microencapsulation with interfacial polymerization and/or the process whereby the biocide is functionalized to allow immobilization of the biocide within the shell of the microcapsule or porous microsphere. In a preferred embodiment, the biocide has a NH functionality and is reacted with an isocyanate functionality.

The present invention refers to biocidal microcapsules and a process for the production of biocidal microcapsules acting through two different mechanisms: biocide releasing and by contact. This ability is provided by biocides physical/chemical immobilization within the microcapsules core and on the shell, respectively. These novel hybrid microcapsules with biocidal effect will mainly provide a long-lasting and efficient antifouling effect, because the biocide is partially grafted within the shell and, at the same time, they offer a controlled release of biocidal agents. In addition, it is also possible to provide a total biocidal activity by contact, obtained from the full biocides immobilization within the microcapsules shell by covalent bonds (grafting). Thus, the new hybrid microcapsules (biocide-polymer material) allows the reduction of toxic agents into the environment and/or avoid their release, becoming a potential environmental friendly alternative for the conventional releasing antifouling processes, currently allied to serious environment side-effects and strict regulations.

Biocides being only immobilized in the microcapsules core have been described in US2007/053950, US2006/0251688, US2006/246144 and WO00/05952. In contrast with said prior art microcapsules, the biocides in accordance with the present invention are also chemically immobilized in the microcapsules shell reason why these can act by contact as will be clear from the detailed description of the present application.

The hybrid biocidal action, by contact and by biocide release of the microcapsules allows for their further application as an antifouling and/or antimicrobial additive for the formulation of polymeric materials (e.g.: varnishes, paints, adhesives, foams, fibers, etc.), and any other matrix or medium able to support and/or disperse the microcapsules, in order to providing antifouling properties by releasing and contact. For instance, those antifouling materials can be found in polymers industry, marine and fluids transport and treatment industrial systems or even agricultural sector where reducing contamination and toxic level of antifouling products is a priority. The claimed microcapsules are therefore a new environmentally friendly alternative for biofouling control.

The biocidal microcapsules of the present invention are synthesized by a water-in-oil (W/O) microemulsion method combined with interfacial polymerization. The biocides are incorporated either in the aqueous phase or in the organic phase or both, with contents ranging from 0 to 60 wt. %. Depending on the biocide and/or modified biocide physical/chemical properties and purity, the optimum reaction conditions allow for the achievement of microencapsulation yields as high as 90±5%.

The biocides to be used are typically biocides with recognized antifouling effect, in accordance with the present invention, are immobilized within the core and shell of a polymeric microcapsule (FIG. 1).

FIG. 1 illustrates the biocide immobilization in microcapsules (MCs): a) encapsulated in the MCscore; b) chemical immobilized within the MCs shell; c) combining both the encapsulation and chemical immobilization in the MCs core and within the MCs shell.

Microencapsulation/immobilization of biocides in accordance with the present invention ensures that the part of the biocide remains chemically fixed, thus avoiding the releasing of biocide into the environment, also becoming a potential, non-toxic and “environmentally friendly” alternative.

The microencapsulation method in accordance with the present invention for the microcapsules synthesis is the microemulsion method combined with interfacial polymerization, since it promotes the formation of microcapsules with high mechanical strength and stability, then becoming difficult to break and facilitating the incorporation of those developed MC's into polymeric coatings.

The encapsulation method claimed in the present invention, comprises mainly:
i. microencapsulation of biocides within the microcapsules core together with their chemical immobilization by covalent bonds within the microcapsules shell;
ii. chemical immobilization by covalent bonds of functionalized biocides within microcapsules shell.

For both strategies a water-in-oil (W/O) microemulsion method combined with interfacial polymerization is applied.

According to a specific embodiment, polyurethane-polyurea microcapsules (MC's) are synthesized by a microemulsion method combined with interfacial polymerization, following two combined strategies for biocide (for example Econea®, 2-(p-chlorophenyl)-3-cyano-4-bromo-5-trifluoromethyl pyrrole) microencapsulation: a) the encapsulation of biocide in the microcapsules core, thus acting by a controlled releasing mechanism; b) and the immobilization of biocides within the shell of microcapsules by chemical binding, thus acting by contact, thus, avoiding at same time the releasing of toxic agents into the environment. In this last particular strategy it can be considered that the shell composition of the obtained microcapsules and/or microespheres comprises a biocide/polyurethane-polyurea polymeric matrix.

### EXAMPLES

### Example 1

This first example illustrates the partial immobilization of the biocide Econea® [(2-(p-chlorophenyl)-3-cyano-4-bromo-5-trifluoromethyl pyrrole] within the microcapsules of polyurethane-polyurea.

### 1.1. Materials

The biocidalagent used for the encapsulation in this example was the marine antifouling agent Econea®, supplied by Janssen PMP (95%). For the microcapsules (MCs) preparation, toluene (T) (99.8%) and N-methylpyrrolidone (NMP) (99%) were purchased from Sigma-Aldrich. Ongronat 2500® (0) (98%) was supplied by BorsodChem. The surfactant DC193 was obtained from Dow Corning. Etanol (E) (99%) was purchased from Aga. Dimethyl sulfoxide (DMSO) (99.5%) was supplied by Lab-Scan, Analytical Sciences. All the chemicals were used as received and without further purification.

### 1.2. Biocidal Microcapsules Synthesis

The biocidal microcapsules synthesis involves the mixing of two different composed solutions (organic and aqueous), which results in a water-in-oil (W/O) microemulsion involving a simultaneousinterfacial polymerization reaction, which promotes the formation of polyurethane-polyurea shell microcapsules.

The conditions of this microcapsules synthesis process are modified in accordance with the biocide(s) immobilization mechanism involved, this is, chemical immobilization within the microcapsules shell (second strategy) and/or encapsulation in the microcapsules core.

### 1.2.1. Microencapsulation of Econea® Biocide

The microencapsulation of the biocide, as it is received by the supplier, involves both the encapsulation in the microcapsules core and chemical immobilization within microcapsules shell of the biocide. It constitutes one of the most interesting obtained systems, since it illustrates the ability of this process to provide a hybrid system able to work by biocidal agent releasing as well as by contact, opening the range of its action and applicability, moreover when different biocides are immobilized in a same microcapsule system. This synthesis process involves in a first stage the mixing of two solutions: Solution 1 (organic phase) composed by 18.75 mL of toluene and 6.25 mL of Ongronat 2500®; and Solution 2 (aqueous phase) composed by distilled water (20 mL), surfactant DC193 (1 mL) and finally the biocide Econea dissolved in NMP with a content of 50 wt. %. The amount of biocide solution was adjusted in order to obtained in the final mixture 20 wt. % of biocide. The amount of the encapsulated biocide can be optimized in accordance with the desirable biocidal effect on the final application. Where for lower contents the biocide content could be too low to achieve a potential biocidal effect, this should be particular consider if the microcapsules are further incorporated in a matrix or any other support material. On the other hand and for higher contents there could be an significant impact on the final microcapsules morphologic properties, which will also be dependent on the biocide properties, for instance its functional reactivity with the solutions components.

For the above described syntheses cases, after the prior solutions preparation, follows the heating of both Solutions (1 and 2) at 55±5° C., and further mixture of Solution 1 with Solution 2 at vigorous conditions (5000 rpm) by using a UltraTurrax, for about 10-20 minutes. This procedure gives rise to the formation of a microemulsion water-in-oil. The homogenized mixture was following heated to about 55±5° C. and stirred (600 rpm) for 20 to 60 minutes using magnetic mixers.

Along the reaction time, aliquots of the mixture were collected and placed on glass coverslips (1×3 cm) in order to monitoring, by optical microscopy the microcapsules formation.

After validation of MCs formation, the heating of the reaction mixture was stopped. The obtained MCs were filtered under vacuum at room temperature with ethanol, in order to promote their desaglomeration and finally stored in toluene.

The above described procedure is similar for higher biocide contents to be used, whereas components optimization of the different solutions are usually required.

### 1.2.3. Microcapsules Characterization

The main methods/techniques used for the characterization of biocidal microcapsules included: optical microscopy, scanning electron microscopy (SEM), Fourier transform infrared spectroscopy (FTIR), leaching tests and bioassays.

### Optical Microscopy

The obtained biocidal microcapsules were observed on a zoom stereo microscope—A. Kruss, MSZ 5600, after being dispersed in ethanol.

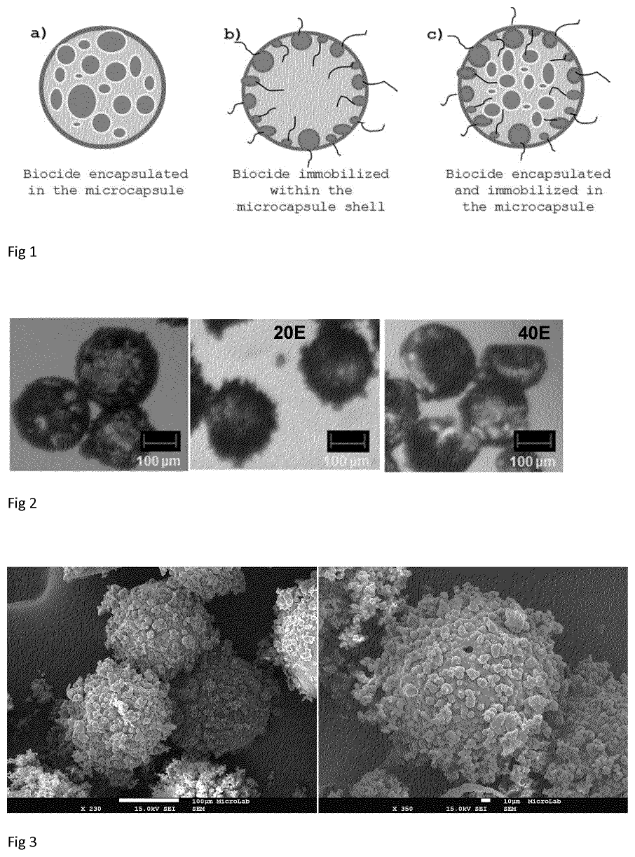

Representative images of the obtained MCs can be found in FIG. 2.

FIG. 2 shows optical images obtained for polyurethane-polyurea microcapsules containing encapsulated and chemical immobilized Econea (E): from left to right: MCs without biocide; MCs obtained from a microemulsion containing 20 wt. % of Econea (20E) and 40 wt. % of Econea (40E).

These optical microscopy (OM) images of developed MCs with partial immobilized biocide within MC's shell, leaded to well-defined MC's shape and size uniformity (average size ranging from 100 to 200 μm). Degradation of their morphology was shown to occur for higher Econea contents (>40 wt %) used in the original MCs synthesis microemulsions. This result is somehow expected, since polymeric shell formation is disturbed by biocide binding.

The yield of microencapsulation is a parameter which expresses the efficiency of MCs synthesis, taking into account the obtained amount of MCs and the amount of reactants involved in the reaction. The yield has been calculated by dividing the weight of the microcapsules by the weight of the reactive compounds for the shell formation (e.g. distilled water and Ongronat 2500®) [S. Lu, J. Xing, Z. Zhang, G. Jia, Preparation and Characterization of Polyurea/Polyurethane Double-Shell Microcapsules Containing Butyl Stearate Through Interfacial Polymerization, Vol. 121 (2011) 3377-3383]:

The obtained average yield was found to be around 90±5%.

### Scanning Electron Microscopy (SEM)

The morphology of the synthesized biocidal microcapsules was characterized by scanning electron microscopy (SEM), using a JEOL 7001F (JEOL, Tokyo, Japan) SEM-FEG (Field Emission Gun) microscope.

The samples were placed in the sample holder using conductive adhesive tape with double face. Thereafter, were covered with a conductor film of Au/Pd, of about 20 nm thick. All observations were made with electrons beams of 15 kV.

SEM images obtained for developed MCs are shown in the FIG. 3.

FIG. 3 SEM images of polyurethane-polyurea microcapsules containing encapsulated and chemical immobilized Econea obtained from a microemulsion containing 20 wt. % of Econea (20E) and a aqueous phase composed by distilled water. On the right details of a peculiar microcapsule with a hole or crater.

FIG. 3 evidences that MCs with encapsulated/immobilized Econea have a spherical and uniform shape. It can be also observed that agglomeration of smaller microcapsules occurs on the surface of larger microcapsules. In addition, a small detected hole in a particular MC, this is a lack of polymeric material in the microcapsule surface, can suggest that an extraction of a small microcapsule was promoted during samples preparation for SEM observation. The average MCs diameter, ranging from 100 to 200 μm, is in agreement with the sizes determined from optical microscopy (FIG. 2).

### Fourier Transform Infrared Spectroscopy (FTIR)

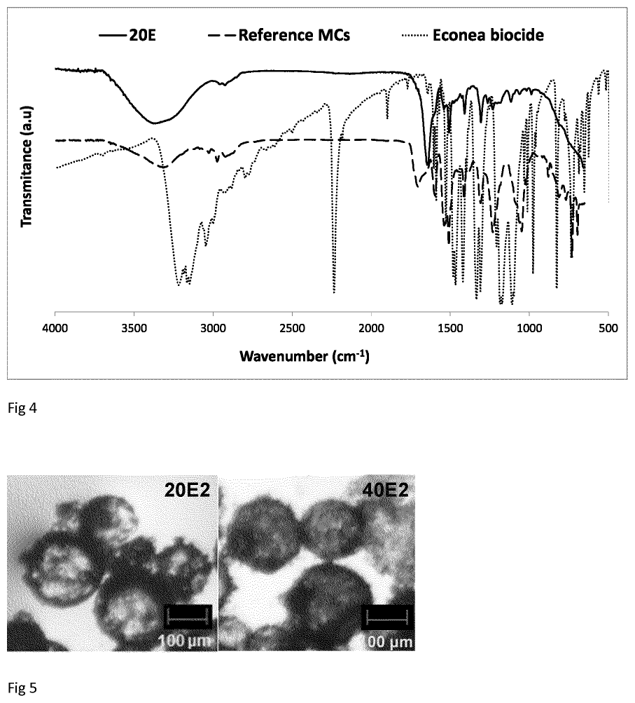

FTIR spectroscopy analyses (FIG. 4) were performed on a Nicolet 5700 (Thermo Electron Corporation), with a kBr beam splitter and a DTGS-TEC detector in the middle-infrared region, using an ATR accessory with a diamond crystal with a 4 cm⁻¹ resolution and 128 scans.

FIG. 4 FTIR spectra of polyurethane-polyurea microcapsules with immobilized Econea biocide. 20E corresponds to the microcapsules obtained from microemulsions containing 20 wt. % of Econea biocide, respectively.

From the spectra in FIG. 4 it is clearly identified the presence of water (0-H stretching) by the presence of the band ranging from at 3600 to 3200 cm⁻¹. It can also be confirmed the presence of the N—H stretching band at 3400 to 3200 cm⁻¹ and particularly for the reference MCs the maximum at 1510 cm⁻¹ of the N—H bending, which can be associated to the presence of both polyurethane and polyurea, also confirmed by the characteristic bands of these polymers. For instance, the urethane bonds presence in this reference MCs is evidenced by the maximum at 1228 cm⁻¹ (C—O stretching), and carbonyl groups at 1700 cm⁻¹ (C═O from urethane). Whereas urea presence is identified by the characteristic carbonyl band of urea at 1690-1660 cm⁻¹ (C═O stretching). This clearly confirmed that MCs of polyurethane-polyurea were synthesised. On the other hand and for the obtained biocidal MCs spectra (20E), this is containing immobilized biocide, the described polymers characteristic bands suffer a shift for lower wavenumbers, close to the typical C═O stretching of urea bonds. This result corroborate the increase of urea bonds formation with the biocide incorporation in the systems, thus evidencing the reaction of the NH functionality of Econea biocide structure with the isocyanate Ongronat component, also meaning that Econea was able to be linked to the polymeric matrice of the MCs.

In addition, the Econea presence can be identified by the appearance of the maximum at 2233 cm⁻¹ (C≡N stretching), at 1097 cm⁻¹ (C—F stretching) and at 825 cm⁻¹ (C—Cl stretching). However, for the synthesised biocidal MCs, 20E, the characteristic band with a maximum at 2233 cm⁻¹ (C≡N stretching) was not detected, which was associated to the lower biocide contents used.

### Bioactivity Assessment

Bioassays were performed to assess the antimicrobial activity against Staphylococcus aureus (ATCC 25923) by the Well diffusion method, at different mediums (artificial sea water (Sera marine salt), DMSO and MilliQ water). Initially, the microorganisms were cultured on Muller-Hinton agar for bacteria Staphylococcus aureus. Then, 100 μL of a standardized microorganism suspension, corresponding to 0.5 McFarland, was used to inoculate a Petri dish of solid Mueller-Hinton medium. These suspensions were spread over the medium surface using a sterile swab. Subsequently, agar wells were made of approximately 5.0 mm in diameter with a Pasteur pipette. Then, 50 μL of each sample, negative control (DMSO) and positive control (Econea) for Gram positive bacteria (Staphylococcus aureus), were added on each of the wells. Plates were incubated at 37° C. for 24 hours. After this period, the diameters of the inhibition zones were measured and the results were expressed in millimeters (mm). The assay was performed under aseptic conditions and in triplicate [M. Pereira, D. Matias, F. Pereira, C. P. Reis, M. F. Simões, P. Rijo, Antimicrobial screening of Plectranthus madagascariensis and P. neochilus extracts, Biomedical and Biopharmaceutical Research, Vol. 12 (2015) 127-138]. Following the above described procedure, different mediums were used to assess the bioactivity of microcapsules, such as artificial sea water, MilliQ water and dimethyl sulfoxide (DMSO) (Table 1).

TABLE 1
Antimicrobial activities of the developed microcapsules and Econea
biocide, at different conditions against Staphylococcus aureus.

| | Inhibition zones (mm) for | | |
|---|---|---|---|
| | Staphylococcus aureus (ATCC25923) | | |
| | Artificial | MilliQ | |
| Sample* | Sea water | water | DMSO |
| 20E | 9 | 12 | 14 |
| 40E | 12 | 12 | 16 |
| Reference MCs | 5 | 5 | 5 |
| (free of biocide) | | | |
| Econea biocide | 20 | 23 | 19 |

*20 wt. % (20E) and 40 wt. % (40E) of biocide in original microemulsions of the obtained MCs. MCs—polyurethane-polyurea microcapsules (MCs);; DMSO = dimethyl sulfoxide.

MCs bioactivity assessment against Staphylococcus aureus bacteria at the different tested mediums (artificial sea water, DMSO and MilliQ water) are significant. All developed MCs, proved to possess antimicrobial activity. The highest bioactivity was found to be in DMSO medium, followed by MilliQ water and by artificial sea water, which was associated to the large solubility of the biocide in DMSO.

Biocide Leaching Assessment from Microcapsules

Leaching tests were performed to determine the occurrence of biocide release from the microcapsule into the surroundings, in this case, artificial sea water.

The tested amount of microcapsules was such to provide the same biocide content or as much close as possible in all MCs samples, this is, about 2-3 wt. % in 7.5 mL of artificial sea water (0.1 L distillated water+3.25 g of salt [sera marin salt, pH=8.3]). Then the mixture was placed on a stirring plate with a rotation speed of 120 rpm. Aliquots of leaching waters were collected after the first 24 hours and after 30 days, to be further assessed in terms of bioactivity by performing bioassays similar to the previous described in item 2.3.

Leaching tests were also performed in dimethyl sulfoxide (DMSO) for some microcapsules for comparative purposes.

TABLE 2
Antimicrobial activities of leachings obtained
from the developed microcapsules, at different conditions
against Staphylococcus aureus.

| | Inhibition zones (mm) for | | | |
|---|---|---|---|---|
| | Staphylococcus aureus (ATCC25923) | | | |
| | Artificial | | | |
| Leachings obtained from | sea water | | DMSO | |
| microcapsules dispersions | 24 | 30 | 24 | 30 |
| (2-7 wt. %)* | hours | days | hours | days |
| 20E | 5 | 5 | 19 | 17 |
| 40E | 5 | 5 | nd | nd |
| Reference MCs | 5 | 5 | 5 | 5 |
| (free of biocide) | | | | |

*About 2-3 wt. % of biocide in 7.5 mL of artificial sea water nd—not determined; DMSO = dimethyl sulfoxide.

Leaching waters obtained from the biocidal microcapsules exhibit antimicrobial activity only when the used medium is DMSO. These behaviour suggests that the highest solubility of the biocide towards DMSO solvent promotes its leaching from the microcapsules

However, on the other hand, in artificial sea water the absence of this bioactivity even after 30 days, can be associated to the lowest biocide solubility in this solvent, which even for longer test periods the biocide rate releasing can be low enough to be undetectable. On the other hand, it should be kept in mind that part of the biocide is chemically immobilized, therefore, leading to a releasing inhibition. For instance the behaviour has not been altered after 30 days of immersion in DMSO.

### Example 2

### 2.1 Microencapsulation of Econea® Biocide Using a Different Microemulsion Composition

This particular example illustrates the possibility to obtain microencapsulation of the Econea biocide by using different conditions, which can also lead to different microcapsules, mainly in terms of shell composition and morphology. The microencapsulation procedure is similar to the one described in example 1, whereas in this case and in order to assess the reagents or raw materials effect on the final MCs composition and biocide encapsulation/immobilization ability, syntheses were performed with a Solution 2, composed by distilled water (0.25 v/v, 5 mL), Diethylene glycol Diethylene glycol (DEG) (99%) (0.75 v/v) and surfactant (DC193). The Solution 1 composition remains the same as in the first example, with one exception: in this case an additional surfactant was required in the organic phase, Span 80 (0.5 mL).

### 2.2 Microcapsules Characterization

### Optical Microscopy

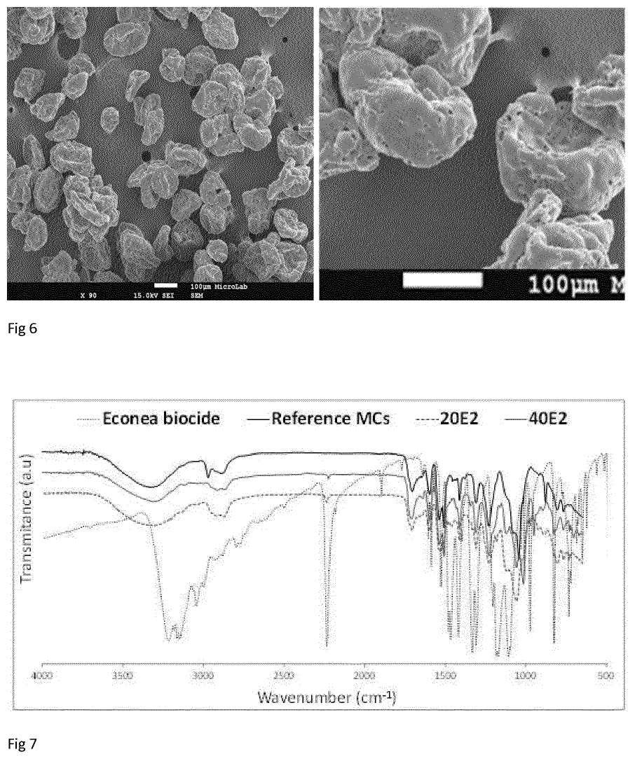

FIG. 5 shows an optical image obtained for polyurethane-polyurea microcapsules containing encapsulated and chemical immobilized Econea, and obtained from a microemulsion containing 20 wt. % (20E2) and 40 wt. % (40E2) of Econea and an aqueous phase mainly composed by distilled water (0.25 v/v) and Diethylene glycol (DEG) (0.75 v/v).

FIG. 5 shows well-defined MCs shape and size uniformity (average size ranging from 100 to 200 μm) of the obtained MCs.

Average yield of microencapsulation around 90±5% was achieved.

### Scanning Electron Microscopy (SEM)

SEM images obtained for the developed MCs are shown in the FIG. 6.

FIG. 6 SEM images of polyurethane-polyurea microcapsules containing encapsulated and chemical immobilized Econea obtained from a microemulsion containing 20 wt. % of Econea (20E) and an aqueous phase composed by distilled water and diethylene glycol (DEG). On the right details of the obtained microcapsules.

FIG. 6 evidences that MCs with encapsulated Econea obtained from an aqueous phase composed by DEG and distillated water, revealed less spherical and uniform shaped MCs, when compared with the previous obtained MCs optical image (FIG. 5). These microcapsules were deformed by the vacuum applied during SEM analysis, meaning less resistance MCs if compared with the ones obtained from example 1. However, they found to possess resistance enough to be further applied in polymeric matrices (Example 3).

### Fourier Transform Infrared Spectroscopy (FTIR)

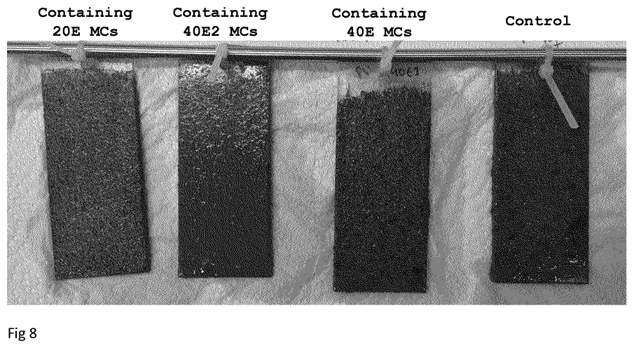

FIG. 7 FTIR spectra of polyurethane-polyurea microcapsules with immobilized Econea biocide. 20E2 and 40E2 correspond to the microcapsules obtained from microemulsions containing a total of 20 wt. % and 40 wt. % of Econea biocide, respectively.

From the spectra in FIG. 7 it is clearly identified the presence of water (0-H stretching) by the presence of the band ranging from at 3600 to 3200 cm⁻¹. The Econea immobilization is evidenced by the appearance of the maximum at 2233 cm⁻¹ (C≡N stretching), at 1097 cm⁻¹ (C—F stretching) and at 825 cm⁻¹ (C—Cl stretching). For both synthesised biocidal MCs, 20E and 40E the characteristic band with a maximum at 2233 cm⁻¹ (C≡N stretching) was detected. It can also be confirmed the presence of the N—H stretching band at 3400 to 3200 cm⁻¹ and the maximum at 1510 cm⁻¹ of the N—H bending, which can be associated to the presence of both polyurethane and polyurea, also confirmed by the characteristic bands of these polymers. For instance, the urethane bonds presence is evidenced by the maximum at 1228 cm⁻¹ (C—O stretching), and carbonyl groups at 1700 cm⁻¹ (C═O from urethane). Whereas urea presence is identified by the characteristic band of urea at 1690-1660 cm⁻¹ (C═O stretching). Thus the obtained MCs spectra evidence the polyurethane-polyurea presence, but urethane bonds are in majority since carbonyl groups at the maximum wavenumber of 1700 cm⁻¹ are mainly identified, with the almost absence of C═O stretching from urea bonds. This is an expected result since DEG presence promote urethane bonds formation with isocyanate groups from the organic phase. It is also evidenced from these spectra that the DEG presence allows to balance the polyurethane-polyurea constitution of the obtained MCs when compared with the MCs obtained from example 1.

### Bioactivity Assessment

Following similar bioassays procedures as example 1, different mediums were used to assess the bioactivity of microcapsules, such as artificial sea water, MilliQ water and dimethyl sulfoxide (DMSO) (Table 3).

TABLE 3
Antimicrobial activities of the developed microcapsules and Econea
biocide, at different conditions against Staphylococcus aureus.

| | Inhibition zones (mm) for | | |
|---|---|---|---|
| | Staphylococcus aureus (ATCC25923) | | |
| | Artificial | MilliQ | |
| Sample* | Sea water | water | DMSO |
| 20E2 | 14 | 12 | 18 |
| 40E2 | 12 | 15 | 19 |
| Reference MCs | 5 | 5 | 5 |
| (free of biocide) | | | |
| Econea biocide | 20 | 23 | 19 |

*20 wt. % (20E2) and 40 wt. % (40E2) of biocide in original microemulsions of the obtained MCs. MCs—polyurethane-polyurea microcapsules (MCs); DMSO = dimethyl sulfoxide.

From Table 4 it is shown that the obtained MCs have an antimicrobial activity against Staphylococcus aureus bacteria at the different tested mediums (artificial sea water, DMSO and MilliQ water). As predicted from example 1, the highest bioactivity was found to be in DMSO medium, as a result of the higher solubility of the biocide in this solvent. On the other hand the MCs 20E2 evidenced a higher antimicrobial activity when compared with the MCs obtained from example 1 in artificial sea water medium and DMSO.

Biocide Leaching Assessment from Microcapsules

Similar leaching tests as described in example 1 were performed for the obtained MCs (Table 4)

TABLE 4
Antimicrobial activities of leachings obtained
from the developed microcapsules, at different conditions
against Staphylococcus aureus.

| | Inhibition zones (mm) for | | | |
|---|---|---|---|---|
| | Staphylococcus aureus (ATCC25923) | | | |
| | Artificial | | | |
| Leachings obtained from | sea water | | DMSO | |
| microcapsules dispersions | 24 | 30 | 24 | 30 |
| (2-7 wt. %)* | hours | days | hours | days |
| 20E2 | 5 | 5 | 20 | 21 |
| 40E2 | 5 | 5 | nd | nd |
| Reference MCs | 5 | 5 | 5 | 5 |
| (free of biocide) | | | | |

*About 2-3 wt. % of biocide in 7.5 mL of artificial sea water nd—not determined; DMSO = dimethyl sulfoxide.

Leaching waters obtained from the biocidal microcapsules exhibit once again antimicrobial activity only when the used medium is DMSO. These behaviour suggests that the highest solubility of the biocide towards DMSO solvent promotes its leaching from the microcapsules.

However, on the other hand, the absence of this bioactivity in artificial sea water medium, even after 30 days, can be associated to the lowest biocide solubility low biocide releasing rate.

### Example 3

### 3.1 Incorporation of Microcapsules in Polymeric Matrices (Marine Paints)

The biocidal microcapsules (MCs) were incorporated in biocide free polyurethane based marine paints (provided by HEMPEL, SA. The resulted formulations were used to coat acrylic plates (6×3 cm) in order to be further assessed in terms of antifouling effect under seawater simulated conditions (aquarium system).

Prior to the incorporation of the MCs in the polymeric matrix, these were subjected to dispersion in order to promote their deagglomeration. Required amounts of MCs, were dispersed in ethanol using an Ultraturrax at a rotation speed of 4000 rpm. It was allowed to evaporate part of ethanol, before re-dispersing the MCs in a compatible paint solvent with a content of approximately 40 wt. % (about 2-3 wt. % of biocide content in the final formulation mixture). This procedure allows the accurate incorporation of MCs into the polymer matrix, avoiding or reducing subsequent problems, such as formation of lumps and roughness in the obtained polymeric films. Finally, the dispersion was added and mixture into two component paint systems. For polyurethane based systems a volume ratio of 11:1 was applied between the polyurethane base component (F0038 Base—F0032) and curing agent (F0038 Cure—95580 as recommended by the supplier.

The prepared formulations (Table 5) were then used to coat the acrylic plate specimens.

TABLE 5
Formulations of the antifouling polyurethane based
marine coatings tested in a sea water aquarium.

| | Microcapsules | | Biocide | |
|---|---|---|---|---|
| Coated | | ¹Content | content | Polymeric |
| Specimen | Type | (wt %) | (wt. %) | matrix |
| PU | — | — | 0.0 | Polyurethane |
| (control) | | | | |
| 1 | 20E2 | 25.35 | 2.54 | |
| 2 | 40E2 | 14.76 | 2.95 | |
| 3 | 40E | 14.79 | 2.96 | |

¹Mass content in the total mixture of the uncured formulation, where E = 4-bromo-2-(4-chlorophenyl)-5-(trifluoromethyl)-1H-pyrrole-3-carbonitrile;

### 3.2 Antifouling Behaviour of Coating Formulations Containing Biocidal Microcapsules

The previous coated specimens were further suspended by steel wires and immersed in a seawater aquarium. The test site is characterized by static conditions, comprising day light exposure comprised between 8 and 12 hours provide by a accurate lamp.

The immersion of specimens was carried out with an average temperature of 24±1° C., a salinity ranging from 35.2 to 36.7 and an average pH of 8.3.

FIG. 8 illustrates the biofouling on specimens coated with antifouling polyurethane based paints, after seven months of immersion in a sea water aquarium. From left to right the immobilized biocidal microcapsules (MCs) in the coatings are: 2.54 wt % of 20E2 MCs, 2.95 wt % of 40E2 MCs, 2.96 wt % of 40E1 MCs and 0 wt. % of MCs, where E corresponds to the biocide incorporated the 4-bromo-2-(4-chlorophenyl)-5-(trifluoromethyl)-1H-pyrrole-3-carbonitrile.

From the tested coated specimens was also the objective to find the best antifouling effect obtained from the immobilization of the produced biocidal microcapsules (Examples 1 and 2). In addition, and for comparative purposes, a specimen coated with an antifouling commercial polyurethane marine paint coating, free of biocidal agents, was also included.

It should be also noted that the formulations prepared did not suffer any optimization after the microcapsules immobilization, but they can require adjustments in order to readjust the original physical-mechanical properties of the paint. Usually such optimizations, if needed, can be performed by experts in the field.

Immersed specimens were inspected weekly and/or monthly depending on the evolution of biofouling formed.

From the inspected antifouling behaviour of the immersed coating specimens, it was observed that only after a immersion period of 7 months occurs significant biofouling formation on the coatings.

Representative images of specimens immersed in the sea water aquarium for this 7 months period can be found in FIG. 8. All tested coating formulations evidenced an unattached biofouling formation after this immersion period. However and taken in account the density and/or affected area by biofouling formation of the coated specimens, it can be observed that the biofouling formation is substantial lower in the case of the specimen coated with the polyurethane coating containing 2.85 wt. % of 40E2 microcapsules, when compared with the other tested formulations, including the commercial antifouling coating currently applied in the field (Control). In this particular case, the total affected area is less then half of the total coated area of the specimen. Whereas for the other coated specimens, all coated area was affected with more or less biofouling density, suggesting the following order: specimen with immobilized 20E MCs>with immobilized 40E MCs≈Control.

From these results it is also concluded that, and for the conditions and biota medium of the immersion tests, the formulations containing the 40E2 microcapsules evidenced the most promising antifouling behavior, which is in agreement with the observed antimicrobial activities for the 40E2 MCs (Example 2). This behaviour was associated to the lower coatings roughness resulting from the lower MCs content required to reach a similar biocide content as for the coating containing 20E3 MCs.

### 3.3. Antimicrobial Activity of Coating Formulations Containing Biocidal Microcapsules

Antimicrobial activity on coating formulation films containing biocidal microcapsules was performed following similar bioassays procedures as the ones described in the previous examples. Different mediums were used to assess the bioactivity of those coating formulations, such as artificial sea water and dimethyl sulfoxide (DMSO) (Table 6).

TABLE 6
Antimicrobial activities, expressed by inhibition
zones against Staphylococcus aureus, of coating
formulations containing biocidal microcapsules.

| Polyurethane based coating | | | | |
|---|---|---|---|---|
| formulations* | | | Inhibition zones (mm) for | |
| | | Biocide | Staphylococcus aureus (ATCC25923) | |
| | Microcapsule | content | Artificial | |
| Sample | type | (wt. %) | Sea water | DMSO |
| PU | — | 0.0 | 5 | 5 |
| 1 | 20E2 | 2.26 | 5 | 11 |
| 2 | 20E | 2.87 | 5 | 5 |
| 3 | 40E2 | 2.85 | 5 | 17 |
| 4 | 40E | 2.86 | 5 | 5 |

| | | | |
|---|---|---|---|
| Econea biocide | — | 18 | 20 |

*Econea biocide (positive control); PU—polyurethane commercial marine paint, free of biocidal agents (negative control); DMSO = dimethyl sulfoxide.

From Table 6, it can be observed that when the used medium is artificial seawater, the coating formulations did not evidenced any antimicrobial activity. This behavior is associated to the low biocide concentration in the films, together with the very low solubility of the biocide in such medium. When the medium used is changed to DMSO and for the time and conditions tested, the formulation containing 40E3 or 20E3 microcapsules showed microbial activity. In this biocidal coatings, the solubility of the biocide in DMSO is one major driving factor, which promotes its leaching from the microcapsules and further from the coating film to its surroundings. From the obtained results it is evident that the composition of microcapsules influences the obtained leaching rates. The microcapsules with higher shell polyurea moieties (20 E and 40E) seems to reduce the biocide leaching ability of the MCs when incorporated in a polymeric film, being and under the biossays conditions undectable or not able to reach the outer surface of the polymeric coating matrix. Whereas for microcapsules shell composed by higher polyurethane moieties the encapsulated biocide is able to leach out, when promoted by a suitable solvent as DMSO. Despite having the antimicrobial behavior differences of the formulations containing 20E2, 40E2 and 20E been clarified only in a stronger biocide solvent as DMSO, it corroborates the antifouling behavior observed from the sea water aquarium tests.

### 3.2. Leaching Tests on Coated Specimens

Leaching of the biocide through the paint films of coated specimens containing the developed biocidal MCs was assessed by leaching tests, following an adapted procedure from the standard OECD 313-2007. Those tests consisted on the coated specimens (6×3 cm) immersion in 100 mL glasses containing artificial sea water (0.1 L distillated water+3.25 g salt [sera marin salt, pH=8.3]) under controlled conditions, and under continuous stirring (rotation speed of 120 rpm) for minimum periods of 30 days. Finally, the antimicrobial activity of the leaching waters was assessed by bioassays against microorganisms such as Staphylococcus aureus, following the same procedure as described in the previous examples.

In Table 6 the obtained inhibition zones against the Staphylococcus aureus bacterium for the tested leaching waters can be found.

TABLE 6
Antimicrobial activities of leachings waters obtained from
the coated specimens against Staphylococcus aureus.

| Leachings waters samples | |
|---|---|
| after 30 days of exposure of | Inhibition zones (mm) for |
| immersed coated specimens | Staphylococcus aureus (ATCC25923) |
| 1 | 5 |
| 2 | 5 |
| 3 | 5 |
| 4 | 5 |
| PU (control) | 5 |
| E | 20 |

E-commercial Econea (positive control); 1 - Specimen containing 2.26 wt % of Econea biocide provided from 20E2 microcapsules (MCs); 3 - Specimen containing 2.87 wt % of Econea biocide provided from 20E MCs;) 3 - Specimen containing 2.85 wt % of Econea biocide provided from 40E2 MCs; 4 - Specimen containing 2.86 wt % of Econea biocide provided from 40E MCs; PU (control) - Coated specimen with a commercial polyurethane marine paint, free of biocides.

As can be seen from Table 6, the tested leaching waters did not reveal any antimicrobial activity, meaning that after 30 days of exposure no biocide releasing was detected. This is an expected result, which is associated to the very low biocide solubility in water and subsequently if any biocide leaching occurs, the amount is so low that the total biocide concentration is not detectable by the microbial test. On the other hand, and since the biocide is partial chemical immobilized in the MCs shell, it is expected that part of the biocide won't leach out from the MCs, thus contributing for leaching waters containing traces of the biocide.

It is clear from the above that Biocidal polyurethane-polyurea microcapsules synthesis by a water-in-oil (W/O) microemulsion method combined with interfacial polymerization, able to support biocides either in the aqueous phase or in the organic phase or both, with contents up to 60 wt. %. The optimum reaction conditions allow for the achievement of microencapsulation yields as high as 90±5%, depending on the biocides or derivatives physical-chemical properties. Biocide immobilization ability through covalent bonds within the microcapsule shell or microsphere matrix, providing these antifouling properties by contact. Thus, avoiding their release into the environment, and therefore extending their biocidal action and avoiding any allied side-effect associated to the Eco toxicity of the biocides. The biocidal microcapsules according to the present invention provide efficient antifouling and/or antimicrobial protection by combined biocidal mechanisms: bioactive agents releasing and by contact (chemically immobilized biocide in MCs shell), representing thereby a long-lasting and non-toxic and/or environmentally friendly antifouling alternative. The present invention provides for compatibility on the immobilization of different biocides in a same microcapsule system, in order to widening the antifouling range of action of the obtained biocidal product, and therefore, providing potential synergistic effects. The biocidal microcapsule of the present invention are compatible with a diversity of polymer systems, which makes them able to be applied in many applications, particularly as ingredients in paint formulations, varnishes, adhesives, foams or fibers formulations and/or in the formulation of polymeric based materials, in the form of coatings or bulk materials. In these strands, they can be applied in antifouling products used for the protection of: marine structures (aquaculture, platforms, ships, etc.), fluids treatment circuits and the like.

1. Biocide containing microcapsules having a core shell morphology or porous polymeric microsphere characterized in that the biocide is fully or partially immobilized within the shell of the microcapsule or porous microsphere

2. Biocide containing microcapsules according to claim 1 whereby the biocide is partially encapsulated within the core of the microcapsule.

3. A microcapsule comprising wherein the material of the shell is a polymer selected from homopolymers, and/or co-polymers and/or organic-inorganic formulated hybrid polymers such as an enriched silica polymer.

4. A microcapsule wherein the polymer is selected from the group comprising polyurethane/polyurea polymer.

5. A polymeric composition comprising the biocide containing microcapsule as defined in claim 1.

6. A polymeric composition according to claim 5 which is a paint composition

7. The use of microcapsules as defined in claim 1 to provide biocidal effect by contact with the organisms to be treated therewith

8. The use of microcapsules as defined in claim 2 to provide biological effect by release and by contact with the organisms to be treated therewith

9. A process of preparing biocide containing microcapsules having a core shell morphology or porous polymeric microsphere said process comprising a water-in-oil microencapsulation with interfacial polymerization.

10. A process according to claim 9 whereby the biocide is functionalized to allow immobilization of the biocide within the shell of the microcapsule or porous microsphere

11. A process according to claim 9 whereby the biocide has a functionality, to react with an isocyanate functionality including NH functionality.
